(19) United States
(12) Patent Application Publication
(10) Pub. No.: US 2009/0295013 A1
(43) Pub. Date: Dec. 3, 2009

(54) METHOD AND APPARATUS FOR MANUFACTURING PLASTIC PRODUCTS

(76) Inventor: Bin Luo, Houjie Dongguan (CN)

Correspondence Address: HOFFMANN & BARON, LLP, 6900 JERICHO TURNPIKE, SYOSSET, NY, 11791, US

(21) Appl. No.: 12/097,633

(22) PCT Filed: Dec. 16, 2005
(86) PCT No.: PCT/IB05/03898

§ 371 Date: Jun. 29, 2009

(51) Int. Cl. B29C 43/52

(52) U.S. Cl. 264/109; 264/234; 425/112

(57) ABSTRACT

A method for manufacturing plastic products, wherein a mold is used having at least one mold cavity with internally moving parts, which moving parts are brought at least partly in a retracted position, wherein plastic granules, in particular powder or a mixture of powder and granules, are introduced into the mold and at least one said moving part is moved in the mold cavity, preferably subsequently, such that the granules, in particular the powder or mixture, are compressed at least partly and melt at least partly.

The invention relates to a method for manufacturing plastic products. The invention relates in particular to such a method utilizing a mold.

For manufacturing plastic products, use is made of injection molding processes. In a general sense, this means that plastic granulate is heated in for instance an extruder until it melts, after which it is pressed under high pressure into a mold cavity. In the mold cavity, which is wholly filled by the plastic, the plastic is allowed to cure by cooling, after which the mold is opened and the product is taken out.

Manufacturing injection molded products requires a relatively costly and voluminous apparatus. Especially the extruder and the injection means are costly, complicated and require a great deal of energy. Moreover, particularly high pressures occur, especially with products having for instance long and/or narrow and/or complicated flow paths and with products having a relatively large projected surface parallel to a closing surface (land area) of the mold. A further disadvantage of injection molding is that relatively much energy needs to be introduced into the plastic granulates in order to heat them sufficiently, often to well above the melting temperature, because otherwise not the whole mold will get filled. During cooling of the product in the mold, that energy needs to be dissipated again, which leads to relatively long cooling times.

In NL1024263 a method is proposed in which moving parts are provided in the mold cavity which, after introduction of the plastic in the mold cavity, are moved such that the space in the mold cavity is reduced. Here, in a surprising manner, use is made of a high speed of those moving parts, as a result of which in an adiabatic manner heat is obtained in the plastic, so that the plastic becomes more liquid again and so, with relatively little pressure, can still fill the whole mold cavity.

In this method, too, it holds that the plastic is melted prior to its introduction into the mold cavity, which requires costly and complicated apparatuses and moreover relatively much energy.

The object of the invention is to provide a new method for forming plastic products in a mold cavity. To that end, a method according to the invention is characterized by the features according to claim 1.

In a method according to the invention, plastic powder is introduced into a mold cavity, after which in the mold cavity an energy impulse is applied to the powder, such that it melts at least partly and fills the whole mold cavity. Subsequently, it can cool in the usual manner and be removed from the mold.

In a method according to the invention, preferably use is made of a mold having at least one mold cavity in which at least one movable part is provided with which the shape and/or the volume of the mold cavity can be adjusted, at least with the mold closed. In particular, after the mold has been closed and the volume of the mold cavity has been made relatively large, the granules, in particular the powder, are introduced into the mold cavity, after which the granules, in particular the powder, are compressed, so that the desired heating occurs. This compression is done in such a manner that essentially an impulse is applied to the granules, in particular the powder, so that heating of the plastic occurs without external heat needing to be added and without the pressure in the mold running up considerably. Surprisingly, it has been found that by applying an impulse to the granules, in particular to the powder, so much adiabatic heat development occurs that the plastic melts and can fill the mold cavity virtually without pressure increase in the mold cavity.

In a particularly advantageous embodiment, the granules, in particular the powder or the mixture, are introduced into the or each mold cavity, after which in a first step at least one movable wall part of the mold cavity, for instance a slide, is pressed against the granules, in particular the powder, with a relatively low speed, for filling the mold cavity with the plastic, after which, next, the same and/or another movable wall part such as a slide is moved against the plastic with relatively high speed, so that a relatively high impulse is applied to the plastic. As a result of this impulse, the plastic will melt without extra supply of heat, so that a compaction of the plastic is obtained and moreover a substantially homogeneous mass can be obtained.

It has been found that by the use of a method according to the invention, the pressure in the mold can be kept relatively low, in any case considerably lower than in conventional injection molding of a comparable product. Moreover, relatively short cooling times are realized because relatively little heat needs to be dissipated. Moreover, granulate does not need to be melted first, which considerably reduces the processing time and the required energy compared with conventional injection molding.

Granules should herein be understood to include at least, though not exclusively, regularly or irregularly shaped elements such as granulate, beads, cylinders and the like. Understood to be included, in particular, are such particles having a maximum size of less than 6 mm, more particularly less than 4 mm. The maximum size is defined as the smallest diameter of an opening through which a granule can pass in any random orientation, which corresponds to the greatest internal direct distance between two points on the surface of the granule. Powder should herein be understood to include at least, though not exclusively, particles having a considerably smaller maximum size than the granules mentioned. Understood to be included in particular are particles having a maximum size of less than 2 mm, more particularly less than 1 mm. Powder herein preferably has such a consistency that it can dust, which means that in free fall under normal atmospheric conditions it attains the maximum fall velocity within a few centimeters. A mixture of powder and granules is understood to include at least, though not exclusively, a combination of powder and granules as defined hereinabove. The powder can for instance account for more than 50% of the volume.

It is preferred when the granules, the powder or the mixture is introduced into the mold cavity with a relatively low moisture content and/or in an environment with a relatively low humidity. Relatively low humidity should herein be understood to include, though without being limited to, an air humidity of less than 75%, more particularly less than 65%. A relative air humidity of at most approximately 60% affords good results.

The invention further relates to a mold for use in a method according to the invention. The invention furthermore relates to a mold having at least one mold cavity, which cavity comprises at least one movable wall part, wherein at least one inlet opening is provided for introducing plastic granules, plastic powder or a mixture thereof into the mold cavity. In contrast with the known injection molds where a liquid plastic mass is introduced, to which the filling means, filling channels and filling openings have been tailored, it suffices here to use a filling opening through which granules, powder or a mixture thereof in dry, solid form can be introduced. Such a mold is simple in construction and use.

The invention further relates to a manufacturing apparatus with a mold having at least one mold cavity with at least one feed opening, provided with supply means for passing plastic granules, plastic powder or a mixture thereof into and through said at least one feed opening.

To clarify the invention, embodiments thereof will be described with reference to the drawing. In the drawing:

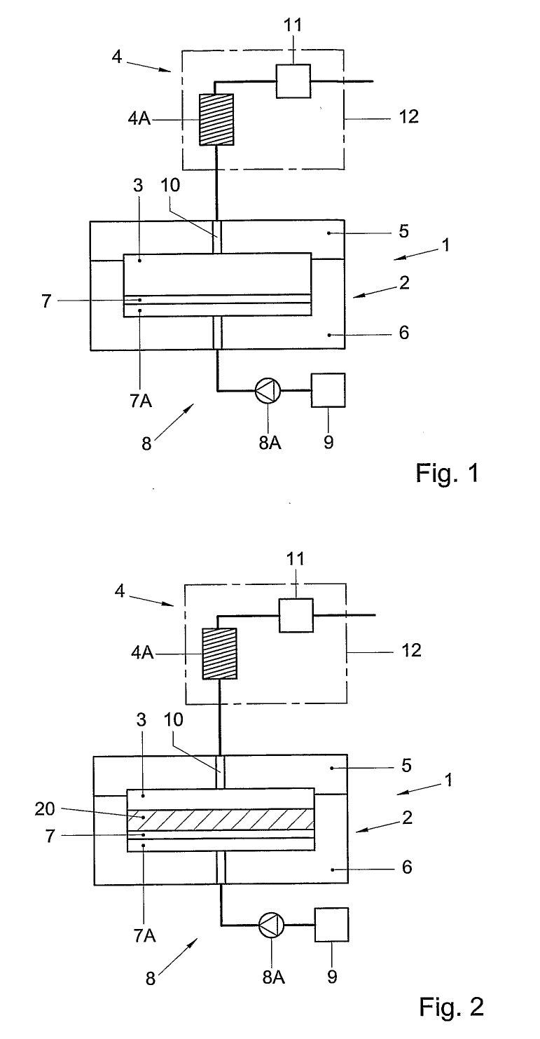

FIG. 1 shows in sectional side elevation a manufacturing apparatus with a mold with supply means according to the invention, wherein a movable wall part has been brought in a retracted position;

FIG. 2 shows an apparatus according to FIG. 1, with the mold cavity partly filled with plastic powder;

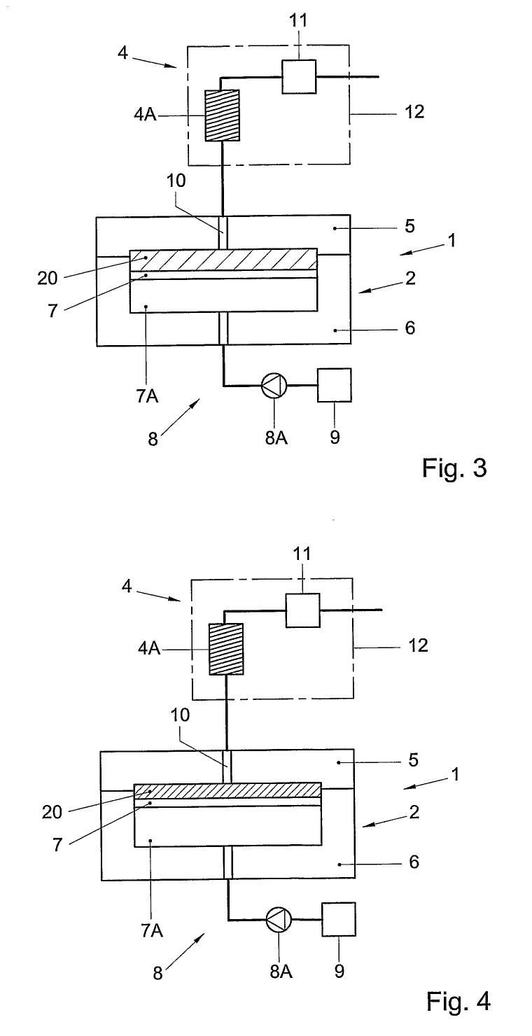

FIG. 3 shows an apparatus according to FIG. 1, wherein the movable wall part in a first phase has been moved forward, such that the whole mold cavity is filled with the powder;

FIG. 4 shows an apparatus according to FIG. 1, wherein the movable wall part in a second phase has been moved further forwards, such that the whole mold cavity has been filled with the powder and the powder has been compacted, whereby the powder has melted and has formed a substantially homogeneous mass having the shape of a product to be manufactured;

FIG. 5 shows a granule or powder particle for use in a method according to the invention, with a maximum size drawn in; and

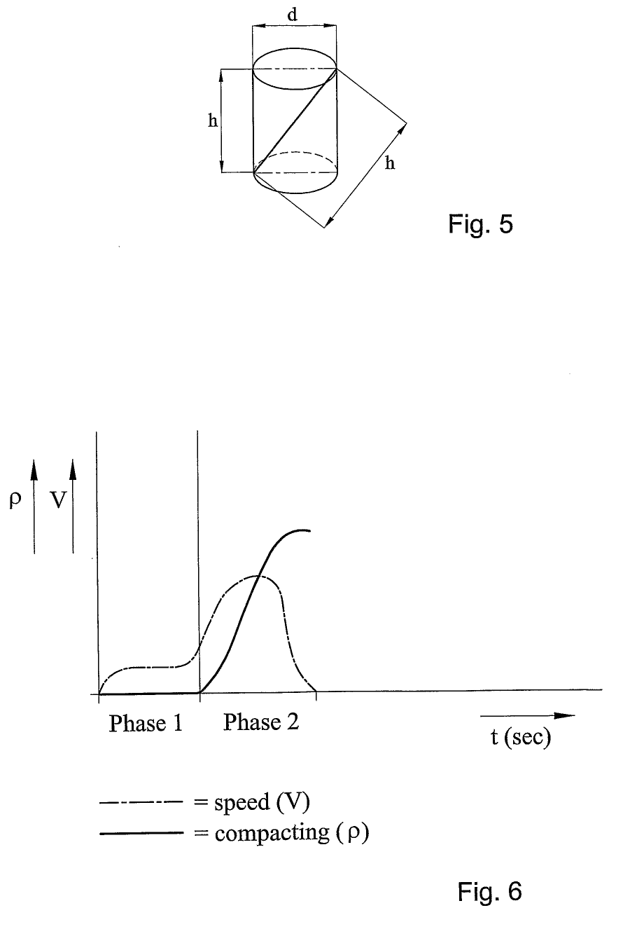

FIG. 6 shows a diagram in which the speed of the movable wall part and the compaction of the plastic in the mold are represented, plotted against time.

In the exemplary embodiments shown, the same or corresponding parts have the same or corresponding reference numerals. The exemplary embodiments given are represented only by way of illustration and should not be construed as limiting in any way.

In FIG. 1 a manufacturing apparatus 1 is shown, provided with a mold 2 with a mold cavity 3 and a supply device 4. The mold cavity 3 is enclosed between a first mold part 5 and a second mold part 6. Provided in the second mold part 6 is a movable wall part 7 which is movable between a first position as shown in FIG. 1 and a second position as shown in FIG. 4. In the first position, the wall part 7 has been brought in a backwardly pulled position, such that the mold cavity 3 has a volume that is greater than the volume of the product that is to be made therein. In the second position, the wall part 7 has been brought into a forwardly moved position, such that the mold cavity 3 has virtually or preferably completely the shape and the volume of the product to be formed.

The movable wall part 7 is connected with drive means 8 for moving the wall part 7 between the first and second position, thereby passing at least a third position, to be further described hereinafter. These drive means 8 can for instance be, but are not limited to, electric, pneumatic or hydraulic means such as a stepping motor, a screw spindle drive, hydraulic or pneumatic cylinders, movable slides or the like. The drive means 8 are preferably controllable by control means 9 such as, though not limited to, a computer with suitable software, cam discs or the like. In the embodiment shown a pneumatic device is shown, comprising a pump 8 for forwarding and removing a pneumatic fluid into and from a chamber 7A behind the plate or movable wall part 7. Using the control means, the drive of the movable wall part 7 can be preferably controlled both with respect to speed and acceleration and with respect to the distance to be traveled. As a result, always the most optimal movement pattern of the movable wall part can be determined and set.

Provided in the first mold part 5 is an opening 10 of a relatively large cross section. The opening 10 can for instance be circular and has for instance a diameter of approximately 1 mm, that is, a surface area of approximately 0.8 mm² or more. The surface and the shape of the opening are preferably tuned to the maximum size of the granules or the powder 20 that is to be passed through it, as will be discussed hereafter. When using granules or a mixture of powder and granules, the opening can for instance have a cross-sectional surface of approximately 3.1 mm² or more than 10 mm². In the embodiment shown, the opening 10 terminates approximately opposite the movable wall part but naturally may be provided at a different position, for instance in a sidewall part of the mold cavity or in the other, second mold part, while also several openings 10 may be provided in the same first and/or the second mold part.

In the embodiment shown, the supply device 4 is an unheated supply device, in which relatively little pressure and heat are generated compared with a known extruder as used in a known injection molding apparatus. This supply device 4 can for instance comprise a conveyor screw 4A (as shown by way of example only), worm, pressure feeder, hopper, gravity feeder or hose pump or other peristaltic pump, but is not limited thereto. Many other types of supply devices can be used, with which, preferably, during supply, granules and/or powder are virtually not heated, at least not above the melting temperature of the plastic of which they are made. If powder or a mixture of powder and granules is used, a grinding device 11 may be provided, before, in or after the supply device 4, with which granulate can be ground to smaller granules and/or to powder. As indicated hereinbefore, granules and powder are distinguished by at least their dimensions. Preferably used as powder is a collection of relatively small particles, while as granules larger particles are used. To be considered in the case of powder, but not limitatively so, are particles having a consistency of milk powder. This is to say that finely ground plastic can be used that is capable of dusting. However, coarser powder can also be used, for instance having a maximum average particle size of less than 2 mm, more particularly less than 1 mm and preferably much smaller than that. To be considered in the case of granules, though not exclusively so, are particles having a maximum size of less than 6 but for instance more than 2 mm. For instance an average maximum size of approximately 4 mm. Herein, for the dimensions mentioned and other numerical values, at least deviations of approximately 5% are to be allowed for, unless stated otherwise. At an average particle size, at least 90% by volume of the amount used should have the average particle size mentioned.

In a method according to the invention, plastic granules, powder or a mixture thereof are introduced into the mold cavity 3, while the movable wall part 7 has been brought into the first, backwardly pulled position, as shown in FIG. 1. As a consequence, and owing to the relatively large opening 10, the powder or the granules or the mixture can be introduced into the mold cavity 3 by means of the supply device 4 in a relatively simple manner and under a relatively low pressure, and fill the mold cavity 3 at least partly. A suitable volume of plastic is introduced into the mold cavity 3, such that the desired product can be manufactured, as shown in FIG. 2.

After the plastic has been introduced into the mold cavity, using the drive means 8 the movable wall part 7 in a first phase is brought relatively calmly to a third position, in which the movable wall part abuts substantially or wholly against the plastic powder, mixture or granules, without exerting much pressure thereon, other than to obtain a substantially wholly filled mold cavity, without giving rise to more than a partial compaction and preferably without compaction of the plastic yet, as shown in FIG. 3.

Next, in a second phase, the or each movable wall part is forced further forwards, using the drive means 8, from the third position to the second position, in which the movable wall part has been moved forwards, that is, in the direction of the mold cavity, such that the plastic is compacted considerably further, as shown in FIG. 4. This movement from the third to the second position proceeds relatively fast in proportion to the movement between the first and the third position. In FIG. 6, these are represented graphically. The speeds are not necessarily given in proportion and will have to be determined per plastic or production, for instance, though not exclusively so, on the basis of the particle size and distribution, the product shape, type of plastic, in particular the melting temperature or the melting range thereof and the moving distance of the or each movable wall part.

Through the first phase, the mold cavity is largely filled with plastic, for instance to a filling degree of more than 60%, more particularly more than 80% and preferably approximately 90 to 95% or more, while the plastic has not melted yet and hence is present as loose, solid particles in mutual abutment. Next, in the second phase, the movable wall part is moved at a high speed against and/or into the plastic. As a result, an impulse is exerted on the plastic, such that heat development occurs in it. Surprisingly, it has been found that through such an impulse, so much heat can be introduced into the plastic adiabatically, that is, without addition of external heat, that the plastic melts and is thereby displaced so as to fill the whole mold cavity. This can involve further compacting, for instance up to 25% or more, while a substantially homogeneous mass is obtained. Surprisingly, it has been found that during compaction and in particular during the exertion of the impulse on the plastic, the pressure in the mold cavity runs up only little, so that the mold can be kept closed with a relatively low pressure. Since the introduction of the plastic also takes place at relatively low pressures, the mold can be kept closed, for instance, with a relatively simple closing mechanism and/or a relatively small press, which saves costs and space.

The mold is preferably entirely closed before the powder or granules 20 are introduced into the cavity 3. This prevents inter alia that the plastic can leave the cavity, which prevents contamination, flashing, inferior products and the like, and provides for a better freedom for designs of products to be made, since the material does not have to be contained entirely in one of the mold parts.

In or at an apparatus 1 according to the invention, preferably a drying device 12 is provided for conditioning the plastic prior to introduction into the mold cavity 3 and/or into the supply device 4. Drying device 12 is herein to be understood to include at least a device with which the relative moisture content of the plastic can be controlled, in particular limited. This can be achieved, for instance but not exclusively so, by blowing dry air through the plastic, by passing the plastic over or through moisture-absorbing means such as textile or moisture-absorbing granules, surfaces, tubes or the like, or by adding to the plastic, for instance, moisture scavengers that bind the moisture, which scavengers can subsequently be separated from the plastic or may be incorporated in the product. Also, the processing of the plastic (whether or not in combination with the above-mentioned drying device) can be carried out under conditioned circumstances, for instance in a conditioned space, so that the relative air humidity and hence the moisture content of the plastic can be controlled. It has been found that it is advantageous to keep the relative air humidity relatively low, for instance below 75%, so that relatively little moisture is introduced along with the plastic into the mold cavity. At a relative air humidity of approximately 60 to 65%, good results were achieved with most plastics. Without wishing to be bound to any theory, it seems that the relative moisture content of the plastic itself can be higher according as the average particle size is greater. Preferred, however, is a low moisture content of the plastic, being preferably virtually dry, for instance containing less than 5% by volume of moisture, more particularly less than 1% by volume of moisture.

As indicated, for each product to be formed, on the basis of inter alia the type of plastic, the particle size used, the shape and dimensions of the product and the like, the layout of the mold will have to be determined, as well as of the drive means, the supply device, and the like. By way of illustration, a few values will be given for a specific product, which, however, should not be construed as limitative in any way. As product, a box was formed with two cover parts mutually pivotable by living hinges. Such a box is for instance known as a conventionally injection molded product (CD box) from NL1001698. In closed condition, the box is for instance approximately 14.5×12.5×1 cm (L×W×H). The product is formed in opened condition, with the cover parts having their respective closing surfaces approximately parallel to each other. Input of the plastic is done adjacent the hinges, while a movable wall part 7 is provided having for each cover part a forming part which is designed to form substantially the inner space of a respective cover part, while moreover ribs are provided for forming the hinges. The movable wall part was brought into the first position, retracted over a distance of approximately 0.5 cm. Next, PP powder was introduced into the mold cavity, having an average maximum particle size in the order of magnitude of 0.1 mm. The powder was passed into the mold cavity 3 by a conveyor screw, at a relative air humidity of approximately 60-65%.

After the suitable amount of powder had been introduced into the mold cavity, which could be introduced into the mold cavity simply and without excessive pressure owing to the relatively large distance between the movable wall part and the opposite wall part, the movable wall part was moved to the third position, so that the plastic filled approximately 90%-95% of the mold cavity. The position of the wall part with the mold closed, and the filling of the mold cavity were read and/or calculated from the position of the drive means. This involved substantially no compacting of the plastic, other than possibly as a result of gravity and any vibrations. Next, in a second phase, the movable wall part was accelerated to a speed above 20 m/sec., in a fraction of seconds, with which the movable wall part was driven against and partly into the plastic powder. The temperature in the plastic was thereby raised above the melting temperature of the PP, so that the plastic became liquid and filled the mold cavity completely, whilst a high degree of compaction occurred. A rough calculation shows that a compacting of the powder of approximately 25% occurred. In the second position, the movable wall part was stopped, after which the plastic was cooled in the mold cavity to a temperature such that the product was stable. Then it was taken out. Visual inspection showed that a product of a homogeneous structure had been obtained, with a tight appearance and the desired accuracy. Also after some time, the cover parts proved to have preserved the desired flatness. The speed in the first phase is preferably less, for instance less than ¾ of the speed in the second phase. Here, in the first phase, movement proceeded at a speed of approximately 15 m/sec.

A same product was manufactured using PE granules, instead of PP powder. The PE granules had an average maximum size of approximately 3.5 mm. Here, in the first phase, the moving wall part was moved in the same manner as in the earlier example, but in the second phase it was accelerated more strongly, to an impact speed of approximately 30 m/sec. As a result, sufficient heat was developed and spread in the plastic to obtain melt of the plastic and filling of the mold cavity, without the pressure in the mold running up excessively. The granules were compacted by approximately 40%. In the first phase, the speed of the movable wall part was approximately 15 m/sec at a maximum. In both cases, the mold could be kept closed with a pressure that was considerably lower than in injection molding a same box with a conventional injection molding apparatus, in particular less than half.

Similarly, with the same and other plastics such as PS and ABS and mixtures of plastics, comparable and other products were manufactured, with equally good results. Addition of an amount of powder to the granules can afford the advantage that a better filling of the mold cavity is obtained in the first phase, so that in certain cases the method proceeds still better. Compacting of the plastic up to 60% or more can be achieved, depending on, for instance but not exclusively, the size of the granules and/or powder, the pressure at introduction, the mold shape, the size and shape of the or each movable wall part and the selected plastic or mixtures of plastics.

It should be emphasized that these are only shown as examples and should not be considered as limiting the invention to for example the materials or speeds, compactations or designs as shown or described.

FIG. 5 schematically shows a granule for use in the invention, which is shown here with a slightly cylindrical shape. A maximum size is inscribed here as a diagonal through the granule. The length L thereof is √(d²+h²) wherein d is the diameter and h is the height of the granule.

The invention is not limited in any way to the exemplary embodiments shown and discussed in the description. Variations thereon are possible within the scope of the invention outlined by the claims.

For example, a mold according to the invention can have more than one movable wall part, and more than one mold cavity may be provided. The mold may be provided with inserts, other divisions, or other constructions and elements known from the injection molding technique. In some cases, cooling means and/or heating means may be provided for cooling a product or, conversely, heating a part of a product in the mold cavity. Further, for instance labeling means may be provided for labeling the products in the mold or outside it. The granules and/or the powder can be introduced into an open mold but preferably they are introduced through the opening or openings mentioned. Optionally, the granules or the powder can be introduced while in a container, for instance be laid in the mold cavity in a bag which fuses with the product or burns or is preserved as an outer jacket. The apparatus may be provided in or on the mold with closing means for closing the mold and/or keeping the mold closed, such as for example clamps, electro magnets, screws or the like, but for this purpose also external means may be used, such as a press.

These and many comparable and other variations are understood to fall within the scope of the invention outlined by the claims.

1. Method for manufacturing plastic products, wherein a mold is used having at least one mold cavity with internally moving parts, which moving parts are brought at least partly in a retracted position, wherein plastic granules, in particular powder or a mixture of powder and granules, are introduced into the mold and at least one said moving part is moved in the mold cavity, preferably subsequently, such that the granules, in particular the powder or mixture, are compressed at least partly and melt at least partly.

2. Method according to claim 1, wherein granules are introduced having an average particle size of less than 4 mm, more particularly less than 2 mm, the particle size being determined by the largest internal dimension of a particle.

3. Method according to claim 1, wherein powder is introduced, in particular powder having an average particle size of less than 1 mm, more particularly a size such that the particles can dust.

4. Method according to claim 1, wherein in the powder, by at least said moving part, a compaction is provided of at least 25%, more particularly at least 50% and preferably more than 60%.

5. Method according to claim 1, wherein said at least one moving part is moved so fast that as a result of the compression of the powder, adiabatic heat development occurs, such that the particles of the powder fuse with each other.

6. Method according to claim 1, wherein the or each moving part is moved with an average speed of more than 10 m/sec, more particularly more than 20 m/sec.

7. Method according to claim 1, wherein the at least one moving part in a first phase is moved relatively calmly in the direction of and/or against the granules, the powder or the mixture, and in a second phase is moved further relatively fast against the granules, the powder or the mixture.

8. Method according to claim 7, wherein the or each moving part in the first phase has an average speed which is less than ¾ of the average speed in the second phase.

9. Method according to claim 1 any one of the preceding claims, wherein the at least one moving part is moved against the powder with an at least partly and preferably substantially flat front side thereof.

10. Method according to claim 1, wherein granulate is ground to powder and subsequently introduced into the mold cavity as powder.

11. Method according to claim 1, wherein the plastic is dried, prior to introduction into the mold cavity.

12. Use of a mold having therein at least one moving wall part, for the formation of plastic products, wherein in the mold cavity, plastic granules, plastic powder, or a mixture of plastic granules and powder, is introduced into the mold cavity and is compressed using the at least one moving wall part, such as to give rise to fusion thereof.

13. A mold having at least one mold cavity, which cavity comprises at least one movable wall part, wherein at least one inlet opening is provided for introducing plastic granules, plastic powder or a mixture thereof into the mold cavity.

14. A mold according to claim 13, wherein said at least one opening has a surface greater than approximately 0.8 mm².

15. A manufacturing apparatus with a mold according to claim 13, provided with supply means for passing plastic granules, plastic powder or a mixture thereof into and through said at least one opening.

16. A manufacturing apparatus according to claim 15, wherein the supply means are unheated.

17. Method for manufacturing plastic product, wherein plastic is introduced into a mold cavity relatively dry, in a non-liquid, non-melted form, where after the plastic is compacted inside the mould at such speed that adiabatic heat is generated inside the plastic, for melting the plastic at least partly, which plastic is subsequently allowed to set by cooling.

18. A method for manufacturing plastic products, wherein a mold is used having at least one mold cavity with internally moving parts, which moving parts are brought at least partly in a retracted position, wherein plastic granules, in particular powder or a mixture of powder and granules, in a non-liquid, non-melted form, are introduced into the mold and at least one said moving part is moved in the mold cavity where the plastic is compacted inside the mould at such speed that adiabatic heat is generated inside the plastic, preferably subsequently, such that the granules, in particular the powder or mixture, are compressed at least partly and melt at least partly, which plastic is subsequently allowed to set by cooling.
